(19) United States
(12) Patent Application Publication
(10) Pub. No.: US 2012/0131483 A1
(43) Pub. Date: May 24, 2012

(54) DRAG-AND-DROP ACTIONS FOR WEB APPLICATIONS USING AN OVERLAY AND A SET OF PLACEHOLDER ELEMENTS

(75) Inventors: ADAM G. ARCHER, NORTH YORK (CA); CURTIS P. D'ENTREMONT, MARKHAM (CA); DEJAN GLOZIC, TORONTO (CA); MICHAEL A. PAWLOWSKI, AURORA (CA); ROBERT RETCHLESS, NORTH YORK (CA)

(73) Assignee: INTERNATIONAL BUSINESS MACHINES CORPORATION, ARMONK, NY (US)

(21) Appl. No.: 12/951,722

(22) Filed: Nov. 22, 2010

(51) Int. Cl. G06F 3/048

(52) U.S. Cl. 715/766

(57) ABSTRACT

In order to improve performance and responsiveness for drag-and-drop actions for Web applications, the amount of JavaScript loaded and executed at each increment of the mouse as it moves during a drag-and-drop action should be minimized. This can be achieved by harnessing the efficient and native-code algorithms built into Web browsers. Instead of using a JavaScript algorithm to compute which drop target the mouse is on, an overlay with placeholders can be placed on top of the page using z-index, where the placeholders are placed directly on top of the drop targets. The current drop target can be computed using the browser's built-in onmouseover and onmouseout events on the placeholder elements, thus freeing the browser from loading and executing too much JavaScript.

### BACKGROUND

The present invention relates to the field of graphical user interfaces and, more particularly, to drag-and-drop actions for Web applications using an overlay and a set of placeholder elements.

Drag-and-drop is the ability to move graphical user interface (GUI) objects by means of manipulating a mouse or other pointing device (e.g., trackball, touchpad, etc.). In many implementations, while a selected object is being dragged, a GUI usually shows a visual representation of the dragged object under the mouse cursor. This permits a user to “see” the object being dragged as the pointer is dynamically moved on the screen. The visual representation of the dragged object is referred to hereafter as an “avatar”.

### BRIEF SUMMARY

One aspect of the disclosure is for a Web application able to be executed and interactively presented within a Web browser. The Web application can include a set of graphical objects, an overlay, and a set of placeholder elements. The graphical objects can include at least one source object and a set of set of drop targets. The source object can be an object able to be dropped at any of the drop targets via a drag-and-drop action. The overlay can be positioned on top of the graphical objects as determined by a z-order of the Web browser. The overlay can be non-visible and can include an onmousemove event handler. The placeholder elements can be on the overlay. Each of the placeholder elements can be non-visible and can be positioned directly on top of a corresponding drop target. Each placeholder element can have a width approximately equal to a visible width of the corresponding drop target and a length approximately equal to the visible length of the corresponding drop target.

Approximately equal in this context represents a length and width determined to be “natural” for sensitive region of the drop target. For example, the placeholder width and height can be greater than the drop target to give extra leeway for dropping objects. Similarly, the width and height can be smaller than the drop target to prevent inadvertent dropping of a dragged object on the wrong target.

Each of the placeholder elements can also include an onmousemove event handler and an onmouseout event handler. The onmousemove and onmouseout event handlers of the placeholder elements can be utilized by the Web application to track which drop target, if any, a GUI pointer is positioned over.

Another aspect of the disclosure is for a method, computer program product, system, and apparatus for handling drag-and-drop actions in a Web application presented in a Web browser. In this aspect, an initiation of a drag-and-drop action can be detected, where the drag-and-drop action occurs in a graphical user interface of a Web application that is visually presented in a Web browser. The graphical user interface can include a set of graphical objects and a set of at least one drop targets. Responsive to the initiation of the drag-and-drop action, a previously deactivated overlay and a set of at least one placeholder elements can be activated within the graphical user interface. If activated, the overlay and set of placeholder elements can be positioned in the z-order of the graphical user interface on top of each of the graphical objects. If deactivated, the overlay and set of placeholder elements will not be positioned in the z-order of the graphical user interface on top of each of the graphical objects. The overlay and the placeholder elements can be non-visible at a time of activation. Each of the placeholder elements can be positioned directly on top of a corresponding drop target and can have a width approximately equal to a visible width of the corresponding drop target and a height approximately equal to a visible height of the corresponding drop target. Movement of a pointer in the graphical user interface can be tracked with an event handler of the overlay. Which drop target, if any, that the pointer is positioned over can be tracked using event handlers of the set of placeholder elements. Responsive to a completion of the drag-and-drop event, the overlay and the set of placeholder elements can be deactivated.

### BRIEF DESCRIPTION OF THE SEVERAL VIEWS OF THE DRAWINGS

FIG. 1 is a system that handles drag-and-drop actions for a Web application using an overlay and placeholder elements in accordance with an embodiment of the disclosure.

FIG. 2 shows a flow chart for a method for handling drag-and-drop actions using an overlay and placeholder elements in accordance with an embodiment of the disclosure.

FIG. 3 shows a screen within with drag-and-drop actions are performed using an overlay and placeholder element set in accordance with an embodiment of the disclosure.

### DETAILED DESCRIPTION

One problem with a conventional drag-and-drop technique is that the drop target can be hidden under other objects. Should this happens, a user may have to stop the dragging, make both the source object and the drop target visible and start again.

Numerous performance issues exist for performing drag-and-drop actions in a Web application presented within a Web browser. For example, if JavaScript (TM) is used to track mouse movement and determine whether a dragged GUI object has been dropped (as well as to optionally move the avatar with the GUI pointer), the JavaScript (TM) must execute repeatedly for every increment that the mouse is moved. The computing resources consumed by the mouse-tracking JavaScript (TM) for drag-and-drop actions can be expensive, as JavaScript (TM) is interpreted. Thus, an end user may experience slow updates, delays as JavaScript (TM) is loaded for each page visit, and other negatives that detract from the overall user experience.

Known solutions to the JavaScript (TM) performance problems all have significant drawbacks. For example, a browser's built-in onmouseover and onmouseout events can be used on target elements to track mouse movement for drag-and-drop actions. If this approach is used, an avatar cannot be placed directly under a GUI pointer, as the avatar will prevent the onmouseover and onmouseout events from firing on the underlying drop targets (in other words the drop targets can be hidden by the avatar). Use of the browser's onmouseover and onmouseout events can be problematic if iframes are included on a page, as iframes can consume mouse events so that the mouse position cannot be accurately tracked. Additionally, problems can exist with hovers, tooltips, and mouse-over highlighting of elements being inadvertently triggered while an object is being dragged over other objects of a Web page.

The disclosure provides a solution for drag-and-drop operations within a Web browser. The solution relies on drop targets, an overlay, and placeholder elements. More specifically, drop targets on a page can be identified, where each drop target is a region to which a source object can be dragged via a drag-and-drop action. If a drag-and-drop action is initiated, a non-visible overlay can be placed on top of the z-order (e.g., z-stack) of a graphical user interface. Thus, the overlay will shield content below the overlay from responding to mouse movements, which prevents inadvertent hovers, tooltips, and mouse-over highlighting. Further, problems related to iframes can be prevented using the overlay. An avatar can be positioned under the overlay so that it does not consume any mouse events (i.e., the mouse events all go to the overlay, which has the onmousemove handler). The avatar can be placed in any desired position relative to the GUI pointer and can be moved as the GUI pointer is moved.

Placeholder elements, which are also not visible, can be defined at positions that correspond to each of the drop targets. Mouseover and mouseout events of the placeholder elements can be used to determine whether a GUI pointer is positioned above any of the drop targets or not.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

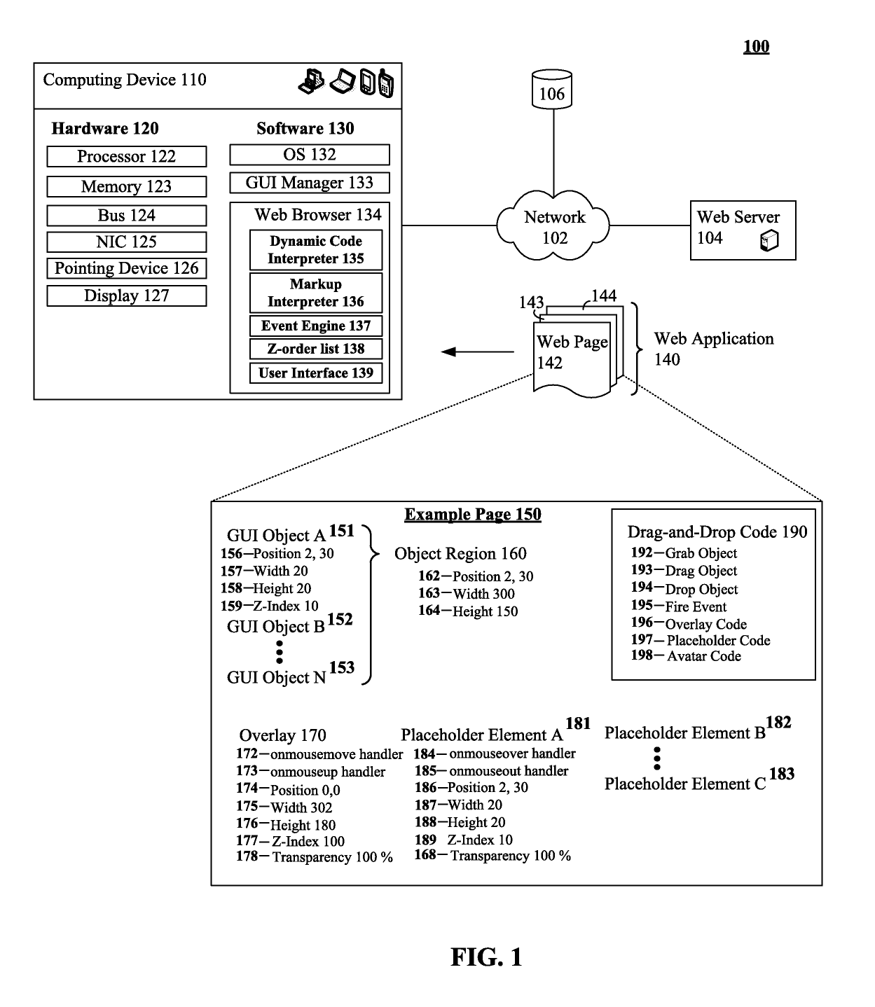

FIG. 1 is a system 100 that handles drag-and-drop actions for a Web application 140 using an overlay 170 and placeholder elements 181, 182, 183 in accordance with an embodiment of the disclosure. For example, the overlay 170 can track mouse movement, which is used to properly position an avatar and other mouse movement related events. An avatar can be a visual representation of an object being dragged during a drag-and-drop action. The placeholder elements 181, 182, 183 can correspond to drop targets of a Web page 142 and can be used to determine whether a source object is dropped on any of these drop targets at a time a drag-and-drop action is being performed.

In system 100, a computing device 110 can execute a Web application 140. The Web application 142 can be conveyed to device over a network 102, such as being served from Web server 104. Web application 142 can also be accessed from a data store 106, which can be a networked data store or a local storage device. The Web application 140 can include a set of Web pages 142, 143, 144, which are linked to each other.

A drag-and-drop action, as noted by drag-and-drop code 190, can be an action that includes a sequence where (1) a graphical object 151, 152, 153 is grabbed (code 192) using a pointing device 126, (2) where the grabbed object is dragged (code 193) across a screen of the display 127, and where the object is then dropped (code 194) on a drop target. This sequence results in a drag-and-drop event firing (code 195) where the source object (the object grabbed) is considered having been dropped at the drop target.

The computing device 110 can be include a personal computer, a notebook computer, a netbook, a smart phone, a kiosk, a home internet appliance, an embedded system, an entertainment console, a navigation system, a media player, and the like. Device 110 can include hardware 120 and software 130, where the software can be stored on a non-transient storage medium, such as a memory 123. Memory 123 can be a volatile or nonvolatile storage space for containing digitally encoded data. Hardware 120 can also include a bus 124, which communicatively links device 110 components, such as processor 122, memory 123, network interface card 125, pointing device 126, display 127 to each other. Other components (not shown) are contemplated.

Pointing device 126 can be a mouse, trackball, touchpad, “air-mouse” or other such device able to direct a GUI pointer (e.g., arrow) presented on a graphical user interface. The pointing device 126 can also permit “click” events to occur, such as by actuating a button on the pointing device. In one embodiment, the pointing device 126 can permit “right click”, “left click” and scroll events.

Each of the software 130 items can also be referred to as a computer program product. The software 130 can include any set of computer readable instructions able to be stored on a memory and able to cause the processor 122 to perform a set of actions. Software 130 can include an operating system 132, a graphical user interface (GUI) manager 133, and a Web browser 134.

The Web browser 134 can be an application able to execute Web application 140, which includes an ability of the Web browser 134 to interactively render Web pages 142, 143, 144. Web browser 134 can include a dynamic code interpreter 135, a markup interpreter 136, an event engine 137, a z-order list 138, and a graphical user interface 139. The graphical user interface 139 can interactively present Web application 140 to a user, once the Web application 140 is loaded into the Web browser 134. Interface 139 can be visually presented on the display 127 and can respond to input from pointing device 126.

Page example 150 shows some of the elements defined for at least a portion of the Web pages 142-144 of the Web application 140. The Web page of example 150 can include a set of elements, such as GUI objects 151, 152, 153 (also labeled Object A, Object B, . . . Object N). These GUI objects 151-153 are able to be presented in the GUI 139, once loaded by Web browser 134. The GUI objects 151-153 can include objects that are able to be a source object and drop targets for a drag-and-drop action. Each of the GUI objects 151-153 can include a number of properties, such as a position 156, width 157, height 157, and z-index 159.

The set of GUI objects 151-153 can be presented in an object region 160 of the GUI 139. The object region 160 has an initial position 162, as well as a width 163 and height 164. Thus, none of the GUI objects 151-153 have presentation or positional values outside the object region 160.

Overlay 170 having a set of position elements 181-183 can be included in the Web page shown by example 150. The overlay 170 can have an onmousemove handler 172, an onmouseup handler 173, position 174, width 175, and height 176, z-index 177, and a transparency 178 value. The position, width, and height values 174-176 can be set to ensure the overlay 170 covers the object region 160. The “coverage” of the object region 160 should cover at least the entire visible region of the GUI interface 139. That is, it is possible for the overlay 170 to not fully cover the object region 160, so long as all visible portions of the region 160 are covered, where visible portions refer to the region of a screen that the pointing device 126 is able to navigate to.

The overlay 170 can be non-visible, which can be accomplished by setting its transparency value 178 to 100 percent or to a fully transparent value. Additionally, a z-index value 177 for the overlay 170 can be set higher than any z-index value of the GUI objects 151-153. This ensures that the overlay 170 is placed in the z-order list 138 on top of any of the GUI objects 151-153. The overlay 170 includes an onmousemove handler 172. Since the overlay 170 has a z-index 177 above other objects 151-153 of the Web application 140, mouse movements can be tracked using the handler 172 without concern of other objects 151-153 intercepting the mouse movement events.

For example, even if one of the GUI objects 151-153 were an iframe (which consumes mouse position), the onmousemove handler 172 will not be affected, as the iframe has a z-index value below z-index value 177 of the overlay 170. Further, the overlay 170 can shield the user interface 139 during a drag-and-drop action to ensure that tool-tips, hovers, GUI pointer highlighting, and other mouse-over effects are disabled on underlying GUI objects 151-153.

The overlay 170 can include a number of placeholder elements 181-183. Each placeholder element 181-183 can correspond to one of the GUI objects 151-153. For example, GUI Object A (151) can correspond to Placeholder Element A (181); GUI Object B (152) can correspond to Placeholder Element B (182); and, GUI Object C (153) can correspond to Placeholder Element C (183). Each placeholder element 181-183 can have position 185, width 187, and height 188 values that ensure the corresponding GUI object 151-153 is covered by the placeholder element 181-183. Additionally, each placeholder element 181-183 can include a transparency 168 attribute set to one hundred percent or to fully transparent. In one embodiment, the z-index value 189 of each position element 181-183 can be equivalent to the z-index value 178 of the overlay 170. In one embodiment, the position elements 181-183 can be positioned above the overlay 170 (e.g., can have a higher Z-index value) to ensure they are not shielded by the overlay 170.

Example page 150 can include drag-and-drop code 190, which controls drag-and-drop actions for the Web application 140. The drag-and-drop code 190 enables grabbing objects 192, such as source objects, via the pointing device 126; dragging objects 193; and, dropping objects 194. Code 190 also fires events 195 that occur in response to a drag-and-drop action being completed. Additionally, overlay code 196 can control the enablement, disablement, and placement of the overlay 170. Placeholder code 197 can control creation, deletion, position, enablement, disablement, and the like of the placeholder elements 181-183. Avatar code 198 controls presentation of an avatar during a drag-and-drop event.

The drag-and-drop code 190 can be Dynamic Hypertext Markup Language (DHTML) code that is interpreted by the dynamic code interpreter 135. For example, code 190 can be JavaScript (TM) code in one embodiment. Code 190 can also utilize Cascading Style Sheets (CSS) and Document Object Model (DOM) standards. In another example, the drag-and-drop code 190 can be written in ActionScript, Caja, JScript, Objective-J, QtScript, WMLScript, ECMAScript, and the like.

In one embodiment, code 190, or a portion thereof, can be incorporated into the software 130 instead of being defined within the Web application 140. For example, the GUI manager 133 can implement grab 192, drag 193, drop 194, and/or fire event 195 portions of the code 190. Additionally, in one embodiment, the Web browser 134 can incorporate code 190 portions, such as incorporating the overlay 196 code, placeholder code 197, and/or Avatar code 198. In one embodiment, the code 190 or a portion of the code 190 can rely on server-side scripting languages, which can include PHP, Perl, JSP, ASP.NET, and the like.

The markup interpreter 136 of browser 134 can interpret the various markup elements of Web application 140. For example, markup interpreter 136 can support Standard Generalized Markup Language (SGML), Hypertext Markup Language (HTML), Extensible Markup Language (XML), Extensible Hypertext Markup Language (XHTML), and other markup languages.

Event engine 137 can handle pointing device 126 actions for Web application 140. Additionally, event engine 137 can enable the onmousemove handler 172, the onmouseup handler 173, the onmouseover handler 184, and the onmouseout handler 185.

The z-order list 138 determines an order that objects of the Web application 140 are stacked relative to each other. Thus, the z-order list 138 stacks objects 151-153, overlay 170, placeholder elements 181-183 in accordance with their respective z-index values (e.g., 159, 177, and 189).

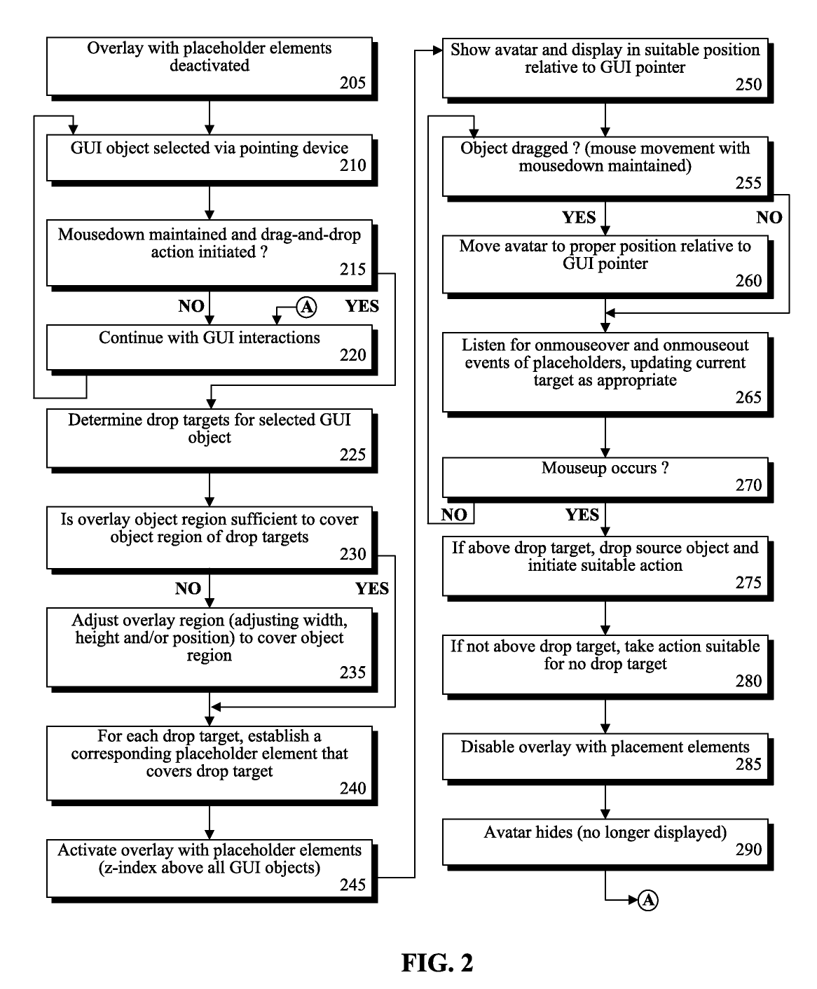

FIG. 2 shows a flow chart for a method 200 for handling drag-and-drop actions using an overlay and placeholder elements in accordance with an embodiment of the disclosure. The method 200 can be performed in the context of system 100 in one embodiment.

The method 200 can begin in step 205, where an overlay with placeholder elements can be deactivated. “Deactivated” means that the overlay with placeholder elements is not above GUI objects (like source and target objects) in the z-order. For example, the overlay and the placeholder elements may not be instantiated within a GUI at step 205. In this context, “deactivated” can also mean that domain object model (DOM) nodes have not yet been created, or that they are not attached to the HTML document node, or that they are made invisible (e.g., using the display: none CSS style, for example). In one embodiment, the GUI being referenced can be a GUI of a Web application, which is rendered within a Web browser.

In step 210, a GUI object can be selected via a pointing device. Selection can result in a visual indicator being shown, such as showing an icon being highlighted or color inverted. The selected GUI object can be considered a source object, which is an object able to be dragged from one location of a screen to another. In step 215, a check can be made to see whether a mousedown action is being maintained, which represents an initiation of a drag-and-drop action. If not, GUI actions can continue as normal, as represented by step 220.

Once a drag-and-drop action is initiated, the method progresses to step 225, where a set of drop targets can be determined for the selected GUI object (e.g., source object). Different source objects can have different drop targets. In step 230, a determination can be made as to whether an overlay object region is sufficient to cover the object region of the drop targets (which region may also include said source object). In step 235, the overlay region can be adjusted to cover the object region, if necessary. Adjusting the overlay region can include adjusting a width, height, and/or position of the overlay.

In step 240, for each drop target, a corresponding placeholder element can be established that covers the drop target. In step 245, the overlay with placeholder elements can be activated. Upon activation, the overlay and placeholder elements can be invisible (e.g., fully transparent) and the z-index value of the overlay and placeholder elements can be greater than the z-index value of any of the other GUI objects on the GUI.

In step 250, an avatar can be shown and displayed in a suitable position relative to the GUI pointer. In step 255, a check can be made to see whether a source object has been dragged. This check can be based on mouse movements occurring with a mousedown action being maintained. If the source object was dragged, step 260 can be performed, where the avatar can be moved to a proper position relative to the GUI pointer.

In step 265, onmouseover and onmouseout events of the placeholders can be listened for. On each mouseover, the method can determine which placeholder it is over and can update the current drop target to the one that corresponds to the placeholder. On a mouseout event, the current drop target can be cleared. If a mouseup does not occur in step 270, the method 200 can proceed from step 270 to step 255. In one embodiment, the mouseup action can be determined using an onmouseup handler of the overlay.

If the GUI pointer is above a drop target in response to the mouseup occurring, step 275 can execute, where the source object is dropped on the drop target. Then a suitable drag-and-drop action can be performed. If the mouseup occurs and the GUI pointer is not above a drop target, a suitable action can occur in step 280. For example, the drag-and-drop can be canceled in step 280.

In step 285, the overlay with placeholder elements can be disabled. In step 290, the avatar can be hidden or no longer displayed. The method can proceed from step 290 to step 220, where additional GUI interactions can continue to occur.

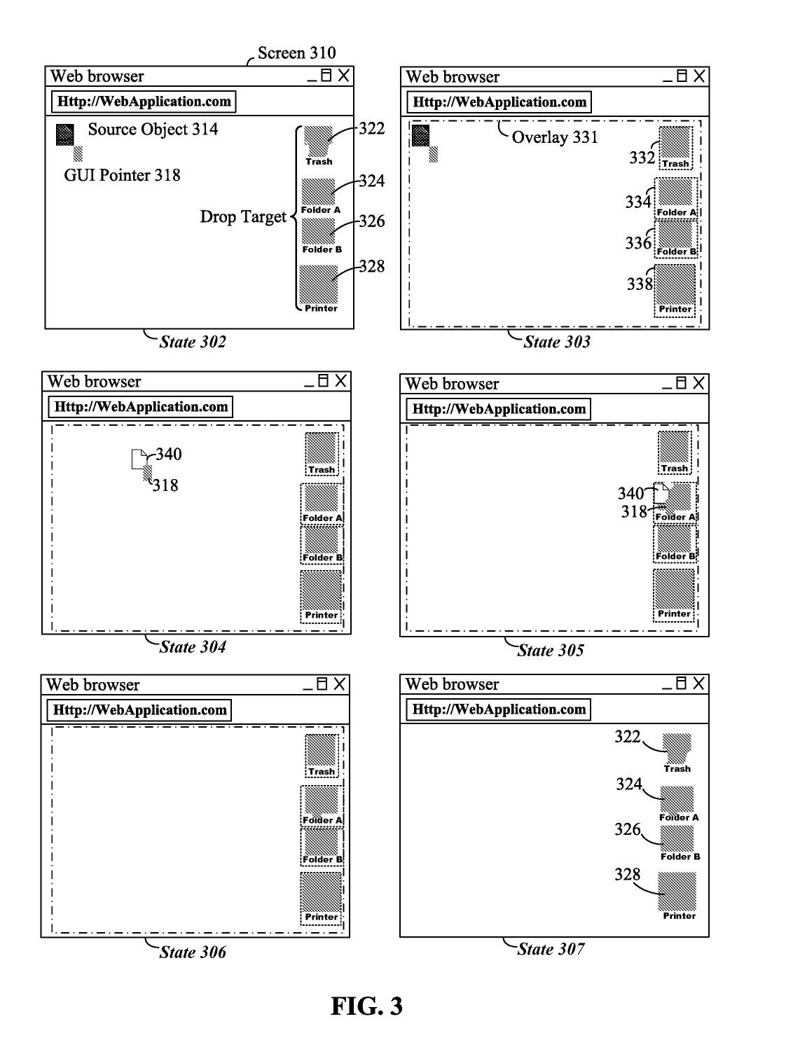

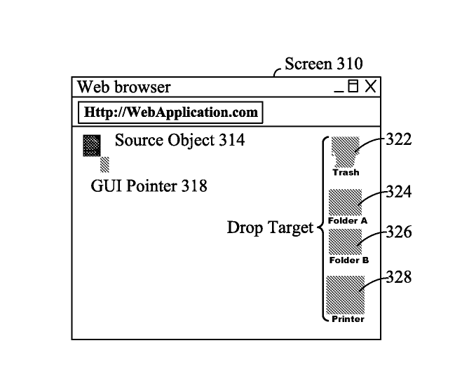

FIG. 3 shows a screen 310 within with drag-and-drop actions are performed using an overlay and placeholder element set in accordance with an embodiment of the disclosure. The screen 310 can be a screen rendered within a Web browser, such as being a Web application. A set of different states (state 302-307) are shown in FIG. 3 for the screen 310.

In state 302, a user can position a GUI pointer 318 above a source object 314 and can then select the object 314, such as by performing a left-click action on a pointer device. Selection of the source object 314 can cause the source object 314 to visibly change, such as highlighting the object 314 to indicate selection. Selection of the source object 314 can be a “grab” phase of a drag-and-drop action. Possible drop targets for the source object 314, as shown in screen 310, include a trash drop target 322, a Folder A drop target 324, a Folder B drop target 326, and a printer drop target 328.

Initiating the drag-and-drop action causes the screen 310 to progress to state 303, where an overlay 331 and placeholder elements 332, 334, 336, 338 are activated. The overlay 331 and placeholder elements 332-338 can be fully transparent and can placed on top of other GUI objects 314, 322-328. Once activated, overlay 331 and placeholder elements 332-338 shield the GUI objects 322-338, and 314 from mouse events. More specifically, the overlay 331 can have an onmousemove handler and onmouseup handler and the placeholder elements 332-338 can have onmouseover and onmouseout handlers.

Once the overlay 310 and placeholder elements 332-338 are activated, the screen can be placed in state 304, where the GUI pointer 318 can be moved. Additionally, an avatar 340 for the source object 314 can be shown in a position relative to the GUI pointer 318. In response to movement of the GUI pointer 318 (as determined by the mousemove events detected by the onmousemove handler of the overlay 331), the avatar 340 can move in a corresponding fashion.

The GUI pointer 318 can move until it is dragged over a drop target, such as Folder A, which is shown in state 305. Next, a mouseup action (or some other action that releases the avatar) can occur. Then, the drag-and-drop action can fire, and the avatar 340 can disappear, as shown by state 306. Further, completion of the drag-and-drop action can cause the overlay 331 and placeholder elements 332-338 to be deactivated, which causes the drop targets 322-328 to be on top of the z-order again, as shown by state 307.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A Web application stored in a non-transient storage medium able to be executed and interactively presented within a Web browser, said Web application upon being interactively presented within the Web browser comprising:
a plurality of graphical objects comprising at least one source object and a set of at least one drop targets, wherein the source object is able to be dropped at any of the drop targets via a drag-and-drop action;
an overlay positioned on top of the graphical objects as determined by a z-order, wherein the overlay is non-visible, and wherein the overlay comprises an onmousemove event handler; and
a set of at least one placeholder elements, wherein each of the placeholder elements is positioned on the overlay or on top of the overlay as determined by the z-order, wherein each of the placeholder elements is non-visible and is positioned directly on top of a corresponding drop target and has a width approximately equal to a visible width of the corresponding drop target and a height approximately equal to a visible height of the corresponding drop target, wherein each of the at least one placeholder elements comprises an onmouseover event handler and an onmouseout event handler, wherein the onmouseover and onmouseout event handlers of the placeholder elements are utilized by the Web application to track which drop target, if any, a GUI pointer is positioned over.

2. The Web application of claim 1, further comprising:
an avatar, which is a visual representation of a dragged object, said avatar being positioned under the mouse cursor and moving in a corresponding fashion as the GUI pointer as the GUI pointer is moved, wherein the onmousemove event handler of the overlay is used to determine a current position of the GUI pointer, which is used to update a current position of the avatar as necessary to ensure the avatar is positioned under the mouse cursor as the mouse cursor is moved.

3. The Web application of claim 1, further comprising:
code causing the overlay and the at least one placeholder elements to be enabled in response to a drag-and-drop action is initiated and to be disabled in response to the drag-and-drop action no longer being active, wherein if enabled the overlay and the at least one placeholder elements are positioned on top of the graphical objects as determined by the z-order and if disabled the overlay and the at least one placeholder elements are not positioned on top of the graphical objects as determined by the z-order.

4. The Web application of claim 1, wherein a cascading style sheet property of the overlay and each of the placeholder elements is set to fully transparent to make the overlay and each of the placeholder elements fully transparent to a user.

5. The Web application of claim 1, wherein the overlay covers at least the visible drop targets shown in the Web browser if the overlay is active.

6. The Web application of claim 1, wherein the overlay comprises a onmouseup event handler configured to determine if a user releases a mouse button in order to drop a source object thereby ending the drag-and-drop action.

7. The Web application of claim 1, wherein the overlay and placeholder elements are defined within markup of the Web application, and wherein code a client-side script of the Web application is used to dynamically enable and disable the overlay and placeholder elements, wherein according to the client-side script the overlay and placeholder elements are only active during a drag-and-drop action.

8. The Web application of claim 1, wherein code of the Web application is configured to:
detect an initiation of a drag-and-drop action;
responsive to the initiation of the drag-and-drop action, activating the overlay, which was previously deactivated as well as the set of placeholder elements on the graphical user interface, wherein if activated, the overlay and set of placeholder elements are positioned in the z-order of the graphical user interface on top of each of the graphical objects, and wherein if deactivated, the overlay and set of placeholder elements are not positioned in the z-order of the graphical user interface on top of each of the graphical objects;
tracking movement of pointer in the graphical user interface with the onmousemove event handler of the overlay;
tracking which drop target, if any, a GUI pointer, is positioned over using the onmouseover and onmouseout event handlers of the set of placeholder elements; and
responsive to a completion of the drag-and-drop event, deactivating the overlay and the set of placeholder elements.

9. A method comprising:
detecting an initiation of a drag-and-drop action presented within a graphical user interface of a Web application that is visually presented in a Web browser, wherein said graphical user interface comprises a plurality of graphical objects and a set of at least one drop targets;
responsive to the initiation of the drag-and-drop action, activating a previously deactivated overlay and a set of at least one placeholder elements on the graphical user interface, wherein if activated, the overlay and set of placeholder elements are positioned in the z-order of the graphical user interface on top of each of the graphical objects, and wherein if deactivated, the overlay and set of placeholder elements are not positioned in the z-order of the graphical user interface on top of each of the graphical objects, wherein the overlay and the placeholder elements are non-visible if activated, wherein each of the placeholder elements is positioned directly on top of a corresponding drop target and has a width approximately equal to a visible width of the corresponding drop target and a height approximately equal to a visible height of the corresponding drop target;
tracking movement of pointer in the graphical user interface with an event handler of the overlay;
tracking which drop target, if any, a GUI pointer is positioned over using event handlers of the set of placeholder elements; and
responsive to a completion of the drag-and-drop event, deactivating the overlay and the set of placeholder elements.

10. The method of claim 9, wherein the initiation of the drag-and-drop event comprises selecting one of the graphical objects as a source object that is to be dragged to a different location of the graphical user interface;
dragging the source object within the graphical user interface by moving the pointer; and
during the dragging, presenting an avatar of the source object in a position under the pointer, wherein the avatar moves as the pointer moves based on tracking movement of the pointer with the event handler of the overlay.

11. The method of claim 9, wherein the initiation of the drag-and-drop event comprises selecting one of the graphical objects as a source object, said method further comprising:
moving the pointer over one of the drop targets while a mouse-down event is active;
detecting that the pointer is over one of the drop targets using an event handler of the corresponding placeholder element positioned on top of the drop target;
detecting a mouse-up even if the pointer is over the drop target; and
responsive to detecting the mouseup event, triggering the drag-and-drop action resulting from the source object being dropped on the drop target.

12. The method of claim 9, wherein the drag-and-drop action comprises:
selecting of one of the graphical objects via a mousedown event while the pointer is positioned over the graphical object;
dragging the graphical object with a pointing device to a desired location of the graphical user interface while a mouse button is held down; and
dropping the graphical object on one of the drop targets by initiating a mouseup event.

13. The method of claim 9, wherein the tracking of movement of the pointer is performed using an onmousemove event handler of the overlay.

14. The method of claim 9, wherein the tracking of which drop target the GUI pointer is positioned over occurs using an onmouseover event handler and onmouseout event handler of the set of placeholder elements.

15. The method of claim 9, wherein the overlay and the placeholder elements both have cascading style sheet properties for background color style set to transparent.

16. A computer program product comprising a computer readable storage medium having computer usable program code embodied therewith, the computer usable program code comprising:
computer usable program code stored in the storage medium that upon being executed by a processor is operable to detect an initiation of a drag-and-drop action presented within a graphical user interface of a Web application that is visually presented in a Web browser, wherein said graphical user interface comprises a plurality of graphical objects and a set of at least one drop targets;
computer usable program code stored in the storage medium that upon being executed by a processor is operable to, responsive to the initiation of the drag-and-drop action, activate a previously deactivated overlay and a set of at least one placeholder elements on the graphical user interface, wherein if activated, the overlay and set of placeholder elements are positioned in the z-order of the graphical user interface on top of each of the graphical objects, and wherein if deactivated, the overlay and set of placeholder elements are not positioned in the z-order of the graphical user interface on top of each of the graphical objects, wherein the overlay and the placeholder elements are non-visible if activated, wherein each of the placeholder elements is positioned directly on top of a corresponding drop target and has a width approximately equal to a visible width of the corresponding drop target and a height approximately equal to a visible height of the corresponding drop target;
computer usable program code stored in the storage medium that upon being executed by a processor is operable to track movement of pointer in the graphical user interface with an event handler of the overlay;
computer usable program code stored in the storage medium that upon being executed by a processor is operable to track which drop target, if any, a GUI pointer is positioned over using event handlers of the set of placeholder elements; and
computer usable program code stored in the storage medium that upon being executed by a processor is operable to, responsive to a completion of the drag-and-drop event, deactivate the overlay and the set of placeholder elements.

17. The computer program product of claim 16, wherein the initiation of the drag-and-drop event comprises selecting one of the graphical objects as a source object that is to be dragged to a different location of the graphical user interface;
computer usable program code stored in the storage medium that upon being executed by a processor is operable to drag the source object within the graphical user interface by moving the pointer; and
computer usable program code stored in the storage medium that upon being executed by a processor is operable to, during the dragging, present an avatar of the source object in a position under the pointer, wherein the avatar moves as the pointer moves based on tracking movement of the pointer with the event handler of the overlay.

18. The computer program product of claim 16, wherein the initiation of the drag-and-drop event comprises selecting one of the graphical objects as a source object, said method further comprising:
computer usable program code stored in the storage medium that upon being executed by a processor is operable to move the pointer over one of the drop targets while a mouse-down event is active;
computer usable program code stored in the storage medium that upon being executed by a processor is operable to detect that the pointer is over the one of the drop targets using an event handler of the corresponding placeholder element positioned on top of the drop target;
computer usable program code stored in the storage medium that upon being executed by a processor is operable to detect a mouse-up event at a time that the pointer is over the drop target; and
computer usable program code stored in the storage medium that upon being executed by a processor is operable to, responsive to detecting the mouseup event, trigger the drag-and-drop action resulting from the source object being dropped on the drop target.

19. The computer program product of claim 16, wherein the drag-and-drop action comprises:
computer usable program code stored in the storage medium that upon being executed by a processor is operable to select of one of the graphical objects via a mousedown event while the pointer is positioned over the graphical object;
computer usable program code stored in the storage medium that upon being executed by a processor is operable to drag the graphical object with a pointing device to a desired location of the graphical user interface while a mouse button is held down; and
computer usable program code stored in the storage medium that upon being executed by a processor is operable to drop the graphical object on one of the drop targets by initiating a mouseup event.

20. The computer program product of claim 16, wherein the tracking of movement of the pointer is performed using an onmousemove event handler of the overlay.
